(19) United States
(12) Patent Application Publication
(10) Pub. No.: US 2026/0370128 A1
(43) Pub. Date: Nov. 19, 2026

(54) OVERCURRENT PROTECTION FOR CONSTANT ON-TIME BUCK CONVERTERS WITHOUT CHAOTIC BEHAVIOR

(71) Applicant: STMicroelectronics International N.V., Geneva (CH)

(72) Inventors: Samuele GISONNO, Torino (IT); Filippo FIORI, Torino (IT); Salvatore Rosario MUSUMECI, Fiumefreddo Di Sic. (IT); Davide LENA, Torino (IT)

(73) Assignee: STMicroelectronics International N.V., Geneva (CH)

(21) Appl. No.: 19/209,160

(22) Filed: May 15, 2025

(51) Int. Cl. H02M 1/32; H02M 1/088; H02M 3/335

(52) U.S. Cl. CPC H02M 1/32; H02M 1/088; H02M 3/33569

(57) ABSTRACT

Disclosed herein is an overcurrent protection (OCP) management circuit for DC-DC converters that maintains frequency synchronization while implementing current limiting during OCP events. The circuit includes a rising edge detector that monitors a frequency synchronization signal, a reset-dominant flip-flop triggered by an external OCP signal, and a logic gate that modifies the frequency synchronization signal based on the flip-flop's output. This configuration separates frequency control from current limiting functions, allowing the converter to maintain synchronization with a reference clock even during overcurrent conditions.

### TECHNICAL FIELD

This disclosure relates to DC-DC converters and, more particularly, to overcurrent protection in constant on-time buck converters with phase-locked loop frequency control.

### BACKGROUND

A DC-DC switching converter may be used to reduce a voltage from a higher level to a lower level. In some applications, such a DC-DC switching converter is used to transfer power from an unregulated input source (e.g., a battery or intermediate power rail) to a regulated output voltage. One type of switching converter is a buck converter that uses a constant on-time loop. This kind of buck converter includes a high-side power switch connected to the input source, a low-side power switch connected to ground, an inductor to conduct current and store energy, and one or more output capacitors to smooth and store the output voltage. Such a converter may set a fixed duration for the high-side power device to remain active (e.g., the on-time), before switching off the high-side power device and switching on the low-side power device for the remainder of the cycle. During the high-side on-time, the inductor current ramps up as energy is transferred from the input source to the inductor. When the converter switches to the low-side device, the inductor current ramps down, releasing stored energy to the output. The sum of these intervals forms the switching period, with the reciprocal of this period being the switching frequency. However, such a converter may experience subharmonic instability when operating in peak-current mode, which may create undesirable oscillations in the output.

One issue experienced specifically by constant-on time buck converters that use a reference clock to manage OCP events is the asynchronization between the reference clock and PWM signal during overcurrent protection (OCP) operating conditions. An OCP circuit may be used to help protect the converter by monitoring the inductor current and forcing the system to turn off the high-side power device when the current exceeds a certain threshold. When an OCP event occurs in these constant-on time buck converters, the on-time is truncated, forcing an off-time. This off time will extend until the next rising edge of a reference clock. Since OCP events are asynchronous with respect to the reference clock, this causes a timing problem where the pulse width modulation signal and the reference clock are not synchronized. When such an asynchronization occurs, the converter may shift to different operating points, the feedback loop and timing can deviate from their nominal behavior thereby causing the inductor current waveform to become erratic, and the output voltage can become unpredictable, particularly under OCP conditions.

In power management integrated circuits, multiple switching converters may operate together, and a phase shift is therefore set between them to reduce ground noise. By phase shifting the switching instants of different converters, input and output current ripple can be reduced, improving overall system performance. If a constant on-time buck converter experiences repeated interruptions from over current protection, this phase shift relationship may be lost. Known approaches may find it challenging to maintain synchronization and phase shifting when the converter truncates on-time in response to current limitation, a maximum current being reached, or an overcurrent protection condition being reached. Consequently, this loss of coordinated switching can increase electromagnetic interference and potential cross-talk among converters. As a result, the risk of increased noise and potential interactions among the converters increases, making reliable operation difficult to achieve.

As such, further development is needed.

### SUMMARY

An overcurrent protection (OCP) management circuit for a DC-DC converter includes a rising edge detector configured to receive a frequency synchronization signal from a frequency control circuit of the DC-DC converter; a flip-flop having a set input configured to receive an OCP signal from an external OCP circuit and a reset input connected to receive a reset signal from the rising edge detector; and a logic gate configured to modify the frequency synchronization signal based on an output of the flip-flop to generate a PWM signal for controlling switches of the DC-DC converter; wherein the frequency synchronization signal maintains synchronization with a reference clock of the DC-DC converter independent of the OCP management circuit operation.

A switching period of the DC-DC converter may equal a period of the reference clock and may include a sum of an on-time signal and a minimum off-time signal in OCP conditions.

The logic gate may include an AND gate having a first input connected to receive an inverted output of the flip-flop and a second input connected to receive the frequency synchronization signal.

The frequency synchronization signal may maintain a constant switching frequency during overcurrent protection events while the PWM signal is modified to limit current.

The frequency synchronization signal may be maintained in phase with the reference clock by a timing loop of the DC-DC converter independent of the PWM signal modification by the OCP management circuit.

The OCP management circuit may be configured to truncate an on-time of the frequency synchronization signal while preserving frequency synchronization with the reference clock.

A method of managing overcurrent protection in a DC-DC converter includes detecting rising edges of a frequency synchronization signal from a frequency control circuit of the DC-DC converter; setting a flip-flop in response to receiving an overcurrent protection (OCP) signal from an external OCP circuit; resetting the flip-flop in response to a detected rising edge of the frequency synchronization signal; and modifying the frequency synchronization signal based on an output of the flip-flop to generate a pulse width modulation (PWM) signal for controlling switches of the DC-DC converter; wherein the frequency synchronization signal maintains synchronization with a reference clock of the DC-DC converter independent of the modification of the frequency synchronization signal.

A switching period of the DC-DC converter may equal a period of the reference clock and may include a sum of an on-time signal and a minimum off-time signal in OCP conditions.

Modifying the frequency synchronization signal may include performing a logical AND operation between an inverted output of the flip-flop and the frequency synchronization signal to generate the PWM signal.

The method may further include maintaining a constant switching frequency of the frequency synchronization signal during an overcurrent condition while the PWM signal has a reduced duty cycle to limit current.

The frequency synchronization signal may be maintained in phase with the reference clock by a timing loop of the DC-DC converter independent of the PWM signal modification.

The method may further include truncating an on-time of the frequency synchronization signal while preserving frequency synchronization with the reference clock during an overcurrent condition.

### BRIEF DESCRIPTION OF THE DRAWINGS

FIG. 1 is a schematic diagram of a constant on-time buck DC-DC converter with overcurrent protection management, as disclosed herein.

FIG. 2 is a timing diagram of the constant on-time buck DC-DC converter with the proposed OCP management during an OCP condition.

FIG. 3 is a timing diagram of the constant on-time buck DC-DC converter demonstrating the overcurrent protection management during an OCP condition.

### DETAILED DESCRIPTION

The following disclosure enables a person skilled in the art to make and use the subject matter described herein. The general principles outlined in this disclosure can be applied to embodiments and applications other than those detailed above without departing from the spirit and scope of this disclosure. It is not intended to limit this disclosure to the embodiments shown, but to accord it the widest scope consistent with the principles and features disclosed or suggested herein.

Note that in the following description, any resistor or resistance mentioned is a discrete device, unless stated otherwise, and is not simply an electrical lead between two points. Therefore, any resistor or resistance connected between two points has a higher resistance than a lead between those two points, and such resistor or resistance cannot be interpreted as a lead. Similarly, any capacitor or capacitance mentioned is a discrete device, unless stated otherwise, and is not a parasitic element, unless stated otherwise. Additionally, any inductor or inductance mentioned is a discrete device, unless stated otherwise, and is not a parasitic element, unless stated otherwise.

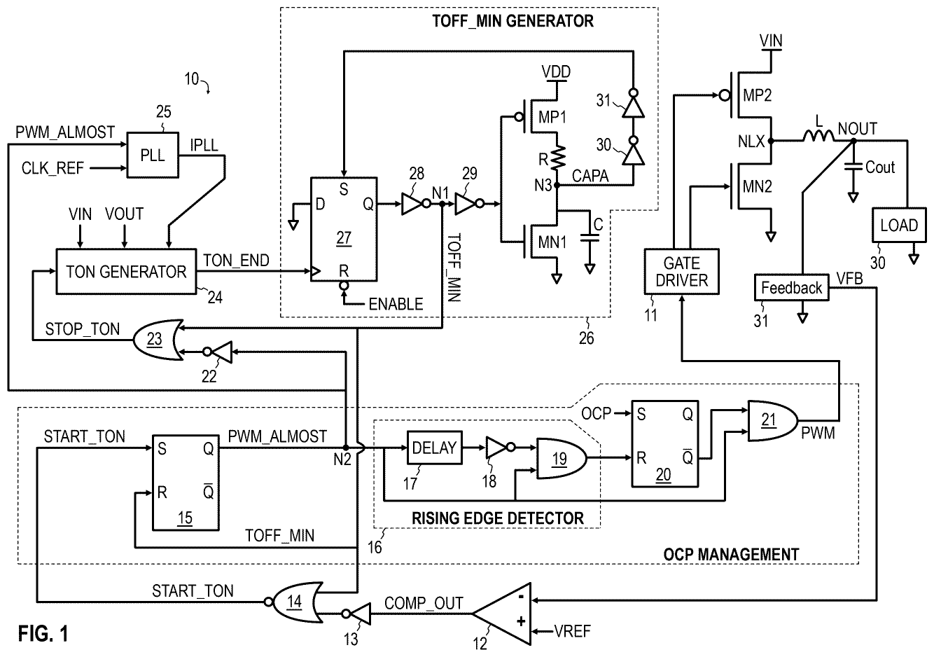

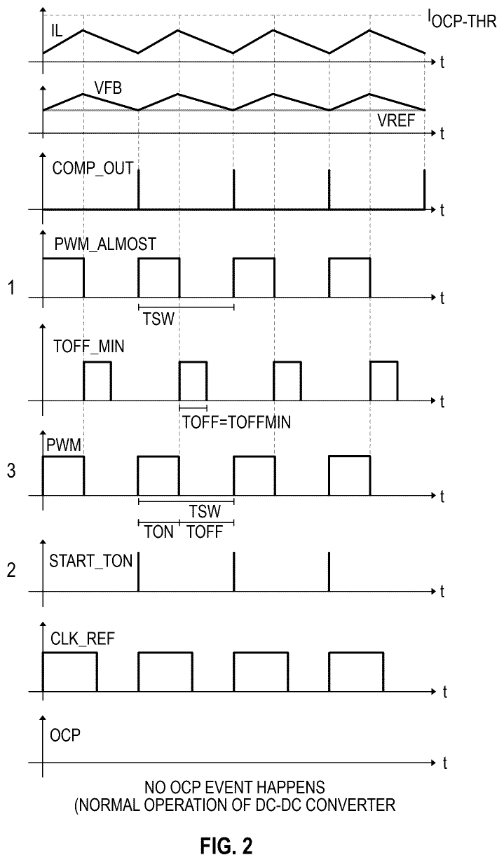

Now described with reference to FIG. 1 and FIG. 2 is a constant on-time buck DC-DC converter 10 that includes a power stage formed by p-channel transistor MP2 and n-channel transistor MN2, with the source of transistor MP2 being coupled to the input voltage VIN, the drain of transistor MP2 being connected to node NLX, and the gate of transistor MP2 being controlled by gate driver 11, and with the drain of transistor MN2 being connected to node NLX, the source of transistor MN2 being coupled to ground, and the gate of transistor MN2 being controlled by gate driver 11. An inductor L is connected between node NLX and output node NOUT. Output capacitor Cout is connected between output node NOUT and ground, and load 30 is connected between output node NOUT and ground. Feedback circuit 31 is connected between node NOUT and ground.

A comparator 12 has its inverting input terminal connected to receive feedback voltage VFB from feedback circuit 31, its non-inverting input terminal coupled to reference voltage VREF, and its output connected to the input of inverter 13. NOR gate 14 has its inputs connected to the output of inverter 13 as well as to node N1. Set-Reset (SR) flip-flop 15 has its set input connected to the output of NOR gate 14, its reset input coupled to receive the off time signal TOFF_MIN, and its non-inverting output connected to node N2, with it being understood that this flip-flop is reset-dominant (i.e. if both the set and reset inputs are active at the same time, the reset input takes priority).

The rising edge detector 16 includes delay block 17 receiving input from node N2, inverter 18 receiving input from the output of delay block 17, and AND gate 19 receiving inputs from node N2 as well as the output of inverter 18; it should be appreciated that any suitable rising edge detector design may be used. Reset dominant SR flip-flop 20 has its set input coupled to receive signal OCP, and its reset input connected to the output of AND gate 19. AND gate 21 has its inputs connected to the inverting output of reset dominant SR flip-flop 20 and node N2, and its output connected to the input of gate driver 11.

Inverter 22 has its input connected to node N2. OR gate 23 has its inputs connected the output of inverter 22 as well as to node N1. On-time generator 24 receives input from the output of OR gate 23, the input voltage VIN, the output voltage VOUT, and a PLL current IPLL generated by phase locked loop (PLL) circuit 25. The PLL circuit 25 has its input coupled to a clock reference CLK_REF as well as to node N2. The output of the on-time generator 24 is connected to minimum off-time generator 26.

In particular, minimum off-time generator 26 includes flip-flop 27 having a clock input connected to the output of on-time generator 24, a data input coupled to ground, a reset input coupled to an enable signal, and a data output connected to the input of inverter 28. The output of inverter 28 is connected to node N1. Inverter 29 has its input connected to node N1 and its output connected to the gates of p-channel transistor MP1 and n-channel transistor MN1. P-channel transistor MP1 has its source coupled to supply node VDD, and its drain connected to node N3 through resistor R. N-channel transistor MN1 has its drain connected to node N3 and its source coupled to ground. Capacitor C is connected between node N3 and ground. Inverter 30 has its input connected to node N3 and its output connected to the input of inverter 31, which has its output connected to the set input of flip-flop 27.

As shown in FIG. 2, the constant on-time buck DC-DC converter 10 implements a ripple-based loop control architecture, which differs from constant frequency architectures (e.g., voltage or peak-current mode). Here, while TON remains constant, the frequency may vary based on operating conditions. The timing diagram of FIG. 2 shows the normal operation of the converter without OCP events, where the inductor current IL forms a triangular waveform as energy transfers between input and output, while the feedback voltage VFB, produced by feedback circuit 31, is compared against reference voltage VREF by comparator 12.

The feedback circuit 31 divides down the output node voltage at node NOUT to generate the feedback voltage VFB. Comparator 12 compares voltage VFB to voltage VREF. As shown in FIG. 2, during normal operation, when voltage VFB falls below voltage VREF, comparator 12 asserts the COMP_OUT signal which, through inverter 13 and NOR gate 14, sets SR flip-flop 15 to initiate a new switching cycle. The output of flip-flop 15 at node N2 triggers the TON generator 24, which then generates a fixed-duration pulse based on the input voltage VIN and output voltage VOUT, as well as the IPLL current from PLL circuit 25. When the TON pulse ends, the minimum off-time generator 26 ensures a minimum off-time period through transistor MP1, transistor MN1, resistor R, and capacitor C (the timing circuit). During this off-time, the power stage switches off as gate driver 11 turns off transistor MP2 and turns on transistor MN2, causing the inductor current IL through inductor L to decrease until voltage VFB again crosses voltage VREF, restarting the cycle.

The implementation proposed here represents one digital realization that has been verified through system level simulations. Other digital implementations that achieve separation of frequency and output voltage loop may be possible.

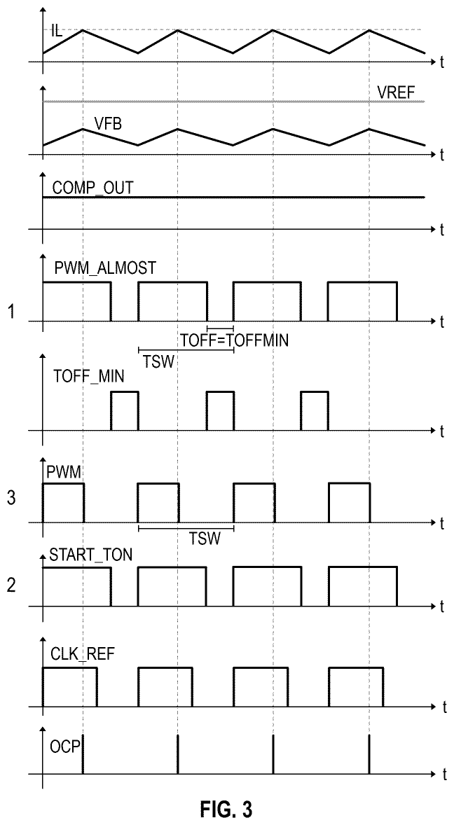

It should be emphasized that the solution presented here maintains normal regulation operating conditions without interference, while adding protection for OCP events. FIG. 2 specifically illustrates the normal operation of the constant on-time architecture without OCP events, while FIG. 3 demonstrates the new OCP operating management solution proposed, showing how the converter maintains proper frequency synchronization during OCP events while preserving normal operating characteristics.

The TON generator 24 operates independently of the PWM signal, instead responding to the PWM_ALMOST signal as controlled by SR flip-flop 15. During operation, the PLL circuit 25 ensures that the switching period follows the relationship Tsw=TCLK_REF=TON+TOFF_MINIMUM, where TON is fixed as TCLK_REF−TOFF_MINIMUM. This relationship is clearly shown in FIG. 2 and maintained in FIG. 3, where this relationship maintains frequency synchronization while allowing for current limiting.

Near the OCP threshold, prior art designs experience unpredictable “V shape” voltage fluctuations. The converter 10 addresses this through its OCP management circuit, where reset dominant SR flip-flop 20 receives the OCP signal at its set input. The rising edge detector 16 processes the PWM_ALMOST signal from node N2 through delay block 17, inverter 18, and AND gate 19, control the reset input of reset dominant flip-flop 20. The output of AND gate 21, receiving inputs from node N2 and the inverting output of reset dominant flip-flop 20, modifies the PWM signal sent to gate driver 11 independently of CLK_REF timing.

During an overcurrent protection event, as shown in FIG. 3, when the OCP signal sets reset dominant flip-flop 20, the reduced output voltage VOUT causes the feedback voltage VFB to fall below VREF at the input of comparator 12. This keeps the comparator output COMP_OUT high. However, because SR flip-flop 15 continues to respond to both NOR gate 14 and the TOFF_MIN signal, the PWM_ALMOST signal at node N2 maintains its timing relationship with the CLK_REF signal through PLL circuit 25. As shown in FIG. 3, the AND gate 21 then modifies this timing to generate the final PWM signal, effectively reducing the duty cycle while preserving the frequency relationship established by the IPLL current adjustment by the PLL circuit of the TON generator 24. As can be appreciated, separation of frequency control and output regulation is achieved in this design, through PLL circuit 25 maintaining frequency control by adjusting the fixed on-time duration (TON) via TON generator 24 through the IPLL current based on CLK_REF, while the OCP management circuit modifies the duty cycle through AND gate 21 and gate driver 11. The TON duration of the PWM_ALMOST signal is set to TCLK_REF−TOFF_MINIMUM, where TCLK_REF is the reference clock period. When OCP events occur, TON of this PWM_ALMOST signal is truncated by the OCP management circuit, resulting in a shorter “real TON” for the final PWM signal compared to the original TON of the PWM_ALMOST signal.

Reset dominant SR flip-flop 20, controlled by the rising edge detector 16 and OCP signal, provides for duty cycle modification without affecting the PLL control loop. This design, where flip-flop 15 generates PWM_ALMOST independently of the OCP intervention, ensures that the PLL circuit 25 maintains constant frequency synchronization with the CLK_REF signal regardless of current limiting events.

Through this arrangement of the rising edge detector 16, reset dominant flip-flop 20, and AND gate 21, the circuit maintains precise timing relationships when multiple converter circuits share the same CLK_REF input. As shown in FIG. 2, the PLL circuit 25 can track variations in CLK_REF timing, allowing the converter to operate with spread-spectrum clock inputs for EMI reduction while maintaining proper current limiting through the OCP management circuit.

Finally, it is evident that modifications and variations can be made to what has been described and illustrated herein without departing from the scope of this disclosure.

Although this disclosure has been described with a limited number of embodiments, those skilled in the art, having the benefit of this disclosure, can envision other embodiments that do not deviate from the disclosed scope. Furthermore, skilled persons can envision embodiments that represent various combinations of the embodiments disclosed herein made in various ways.

1. An overcurrent protection (OCP) management circuit for a DC-DC converter, the OCP management circuit comprising:
a rising edge detector configured to receive a frequency synchronization signal from a frequency control circuit of the DC-DC converter;
a flip-flop having a set input configured to receive an OCP signal from an external OCP circuit and a reset input connected to receive a reset signal from the rising edge detector; and
a logic gate configured to modify the frequency synchronization signal based on an output of the flip-flop to generate a PWM signal for controlling switches of the DC-DC converter;
wherein the frequency synchronization signal maintains synchronization with a reference clock of the DC-DC converter independent of the OCP management circuit operation.

2. The OCP management circuit of claim 1, wherein a switching period of the DC-DC converter equals a period of the reference clock and comprises a sum of an on-time signal and a minimum off-time signal in OCP conditions.

3. The OCP management circuit of claim 1, wherein the logic gate comprises an AND gate having a first input connected to receive an inverted output of the flip-flop and a second input connected to receive the frequency synchronization signal.

4. The OCP management circuit of claim 1, wherein the frequency synchronization signal maintains a constant switching frequency during overcurrent protection events while the PWM signal is modified to limit current.

5. The OCP management circuit of claim 1, wherein the frequency synchronization signal is maintained in phase with the reference clock by a timing loop of the DC-DC converter independent of PWM signal modification by the OCP management circuit.

6. The OCP management circuit of claim 1, wherein the OCP management circuit is configured to truncate an on-time of the frequency synchronization signal while preserving frequency synchronization with the reference clock.

7. A method of managing overcurrent protection in a DC-DC converter, the method comprising:
detecting rising edges of a frequency synchronization signal from a frequency control circuit of the DC-DC converter;
setting a flip-flop in response to receiving an overcurrent protection (OCP) signal from an external OCP circuit;
resetting the flip-flop in response to a detected rising edge of the frequency synchronization signal; and
modifying the frequency synchronization signal based on an output of the flip-flop to generate a pulse width modulation (PWM) signal for controlling switches of the DC-DC converter;
wherein the frequency synchronization signal maintains synchronization with a reference clock of the DC-DC converter independent of the modification of the frequency synchronization signal.

8. The method of claim 7, wherein a switching period of the DC-DC converter equals a period of the reference clock and comprises a sum of an on-time signal and a minimum off-time signal in OCP conditions.

9. The method of claim 7, wherein modifying the frequency synchronization signal comprises performing a logical AND operation between an inverted output of the flip-flop and the frequency synchronization signal to generate the PWM signal.

10. The method of claim 7, further comprising maintaining a constant switching frequency of the frequency synchronization signal during an overcurrent condition while the PWM signal has a reduced duty cycle to limit current.

11. The method of claim 7, wherein the frequency synchronization signal is maintained in phase with the reference clock by a timing loop of the DC-DC converter independent of the PWM signal modification.

12. The method of claim 7, further comprising: truncating an on-time of the frequency synchronization signal while preserving frequency synchronization with the reference clock during an overcurrent condition.

13. A DC-DC converter, comprising:
a power stage including a high-side switch and a low-side switch connected between an input voltage and ground;
a gate driver having an output connected to control terminals of the high-side switch and the low-side switch;
an inductor having a first terminal connected to a switching node between the high-side switch and the low-side switch, and a second terminal connected to an output node;
a feedback circuit connected to the output node and configured to generate a feedback voltage;
a frequency control circuit including:
a phase-locked loop (PLL) circuit configured to receive a reference clock;
an on-time generator configured to receive a PLL current from the PLL circuit and generate an on-time signal;
a first flip-flop configured to generate a frequency synchronization signal synchronized to the reference clock through the PLL circuit; and
a minimum off-time generator configured to receive the on-time signal and generate a minimum off-time signal that resets the first flip-flop; and
an overcurrent protection (OCP) management circuit including:
a rising edge detector configured to receive the frequency synchronization signal;
a second flip-flop having a set input configured to receive an OCP signal and a reset input connected to receive a reset signal from the rising edge detector; and
a logic gate configured to modify the frequency synchronization signal based on an output of the second flip-flop to generate a PWM signal for the gate driver;
wherein the frequency synchronization signal maintains synchronization with the reference clock independent of OCP circuit operation.

14. The DC-DC converter of claim 13, wherein a switching period of the DC-DC converter equals a period of the reference clock and comprises a sum of the on-time signal and the minimum off-time signal in OCP conditions.

15. The DC-DC converter of claim 13, further comprising:
a comparator configured to compare the feedback voltage to a reference voltage and generate a comparison signal; and
wherein the first flip-flop has a set input connected to receive the comparison signal and a reset input connected to receive the minimum off-time signal.

16. The DC-DC converter of claim 13, wherein the on-time generator is configured to generate fixed-duration pulses based on the input voltage, a voltage at the output node, and the PLL current.

17. The DC-DC converter of claim 13, wherein the logic gate comprises an AND gate having a first input connected to receive an inverted output of the second flip-flop and a second input connected to receive the frequency synchronization signal.

18. The DC-DC converter of claim 13, wherein the frequency synchronization signal maintains a constant switching frequency during overcurrent protection events while the PWM signal is modified to limit current.

19. The DC-DC converter of claim 13, wherein the first flip-flop, on-time generator, and minimum off-time generator form a timing loop configured to maintain the frequency synchronization signal in phase with the reference clock independent of the PWM signal modification by the OCP circuit.
